(19) United States
(12) Patent Application Publication
(10) Pub. No.: US 2005/0249784 A1
(43) Pub. Date: Nov. 10, 2005

(54) Preparations containing diformates and short-chain carboxylic acids

(75) Inventors: Michael Schonherr, Frankenthal (DE); Jorn Karl, Mannheim (DE); Alexander Hauk, Ludwigshafen (DE); Gerd Diebold, Reutlingen (DE); Andreas Habich, Speyer (DE); Robert Lenz, Hochdorf-Assenheim (DE); Anna Valeska Lohmann, Limburgerhof (DE); Volker Schmidt, Mannheim (DE)

Correspondence Address: LAHIVE & COCKFIELD, LLP., 28 STATE STREET, BOSTON, MA, 02109, US

(73) Assignee: BASF Aktiengesellschaft, Ludwigshafen (DE)

(21) Appl. No.: 10/521,204

(22) PCT Filed: Jul. 7, 2003
(86) PCT No.: PCT/EP03/07259

§ 371 Date: Jan. 12, 2005

(30) Foreign Application Priority Data
Jul. 12, 2002 (DE) 102 31 894.8
Dec. 23, 2002 (DE) 102 61 578.0

(51) Int. Cl. A23K 1/165; A23K 1/17

(52) U.S. Cl. 424/442; 426/635

(57) ABSTRACT

The present invention relates to preparations comprising at least one diformate of the general formula XH(COOH)₂, where X=Na, K, Cs, NH₄ and at least one short-chain carboxylic acids and/or at least one salt of the short-chain carboxylic acid and/or at least one ester and/or at least one derivative of the short-chain carboxylic acid, and to the use of these preparations.

The present invention relates to preparations comprising at least one diformate and at least one short-chain carboxylic acid and/or at least one salt and/or at least one ester and/or at least one derivative of the short-chain carboxylic acid and to the use of these preparations.

Acid formates and methods for preparing them have been known for a very long time. Thus, Gmelins Handbuch der anorganischen Chemie, 8th edition, number 21, pages 816 to 819, Verlag Chemie GmbH, Berlin 1928, and number 22, pages 919 to 921, Verlag Chemie GmbH, Berlin 1937, describe the preparation of sodium diformate and of potassium diformate by dissolving sodium formate and potassium formate in formic acid. The crystalline diformates can be obtained by lowering the temperature or by evaporating off excess formic acid.

DE 424017 discloses the preparation of acid sodium formates of varying acid content by introducing sodium formate into aqueous formic acid in the appropriate molar ratio. The corresponding crystals can be obtained by cooling the solution.

According to J. Kendall et al., Journal of the American Chemical Society, Vol. 43, 1921, pages 1470 to 1481, acid potassium formates can be obtained by dissolving potassium carbonate in 90% strength formic acid, with formation of carbon dioxide. The corresponding solids can be obtained by crystallization.

GB 1,505,388 discloses the preparation of acid carboxylate solutions by mixing the carboxylic acid with a basic compound of the required cation in aqueous solution. Thus, for example, aqueous ammonia is employed as basic compound in the preparation of acid ammonium carboxylate solution.

U.S. Pat. No. 4,261,755 describes the formation of acid formates by a reaction of an excess of formic acid with the hydroxide, carbonate or bicarbonate of the appropriate cation.

WO 96/35657 discloses the preparation of products which comprise disalts of formic acid by mixing potassium, sodium, cesium or ammonium formate, potassium, sodium or cesium hydroxide, carbonate or bicarbonate or ammonia with optionally aqueous formic acid, subsequent cooling of the reaction mixture, filtration of the resulting suspension and drying of the resulting filter cake, and recycling of the filtrate.

Acid formates have an antimicrobial effect and are employed for example for preserving and acidifying vegetable and animal materials such as, for example, grasses, agricultural products or meat, for treating biowastes or as additive for livestock nutrition.

WO 96/35337 A1 describes animal feeds and animal feed additives which contain diformates, especially potassium diformate.

WO 97/05783 A1 (EP 845 947 A1) describes a method of cooling and preservation of fish in which a cooling medium with formic acid and/or mono/di or tetrasalts of formic acid is employed. In one embodiment, a C1 to C4 monocarboxylic acid is added to the cooling medium.

WO 98/19560 (EP 957 690 A1) describes a method for producing a fish feed in which ammonium, sodium or potassium diformate and formic acid are added to a fish products before addition of further ingredients of the feed and processing to fish feed.

WO 98/20911 A1 (EP 961 620 B1) describes a method for treating wet organic waste in which an aqueous preparation of the mono- and disalts of formate, acetate or propionate is employed.

WO 01/19207 A1 describes a liquid preservative/acidifier for grass, and agricultural products, fish and fish products, and meat products, which contains at least 50% by weight formic acid and formates, ammonium tetraformate and 2-6% by weight potassium or 2-10% by weight sodium in the form of their hydroxides or formates.

These solutions may contain benzoic acid and benzoic acid derivatives. These preparations are used for silage fermentation. Preparations comprising diformates and benzoic acid are not mentioned.

EP 0 683 985 A1 describes animal feeds which a substance selected from lysine, benzoic acid or a salt thereof, an alkali metal salt of a mineral acid and an ammonium salt of a carboxylic acid which is able to keep the pH of the excrement of an animal fed with this feed below pH=7 for at least 24 h.

WO 96/24247 describes preparations for preserving organic material, comprising esters of a substituted or unsubstituted benzoic acid in combination with a further ester of aliphatic C1-C20 carboxylic acids with a C1-C9 alcohol. These preparations may contain formic acid as further component.

WO 98/08499 (EP 921 792 A1) describes preparations containing benzoic acid or benzoic acid derivatives which release benzoic acid in vivo, and the use of these preparations as antibiotics, growth promoters, for reducing the feed conversion ratio and improving the digestibility of amino acids.

WO 96/24248 describes antimicrobial preparations which contain 50 to 99.8% by weight of a substituted or unsubstituted C1-C4 monocarboxylic acid and 0.2% to 30% by weight of an ester of a substituted or unsubstituted benzoic acid.

It is a disadvantage of the prior art preparations inter alia that they lack a selective effect on microorganisms. In the livestock nutrition sector it is particularly desirable to selectively influence pathogenic microorganisms (such as, for example, E. coli, Salmonella) while simultaneously retaining and/or promoting the desired microflora. This is insufficiently possible with the prior art preparations.

It is an object of the present invention to provide preparations which can be employed in particular in livestock nutrition as performance enhancers and growth promoters and show an improved performance profile compared with prior art preparations while at the same time being easy to handle industrially. Preparations with good storage stability are of special interest.

There is special interest in this connection in preparations which bring about a reduction in the pH in the animal's urine.

We have found that this object is achieved by the preparations of the invention, which are particularly suitable for use in livestock nutrition. These preparations show synergistic effects in terms of their performance-enhancing, growth-promoting and preserving properties in relation to the prior art preparations.

The invention accordingly relates to preparations comprising
(i) at least one diformate of the general formula
   XH(COOH)₂, where X=Na, K, Cs, NH₄ and
(ii) at least one short-chain carboxylic acid and/or at least one salt of the short-chain carboxylic acid and/or at least one ester of the short-chain carboxylic acid and/or derivative of the short-chain carboxylic acids.

Diformates and their preparation are described in the prior art. The diformates to be employed according to the invention are obtainable for example by the process described in EP 0 824 511 B1 or by the processes described in the as yet unpublished German patent applications DE 101 547 15.3 and DE 102 107 30.0.

Suitable diformates are sodium diformate, potassium diformate, cesium diformate and ammonium diformate. In a preferred embodiment, potassium diformate is employed as diformate. In a further embodiment, said diformates can be employed mixed with one another.

The preparations of the invention comprise short-chain carboxylic acids and/or salts of the short-chain carboxylic acids and/or esters of the short-chain carboxylic acids and/or derivatives of the short-chain carboxylic acids.

Short-chain carboxylic acids mean for the purposes of the invention carboxylic acids which may be saturated or unsaturated and/or straight-chain or branched or cyclic and/or aromatic and/or heterocyclic. “Short-chain” means for the purposes of the invention carboxylic acids containing up to 12 C atoms, in particular up to 10 C atoms, in particular up to 8 C atoms. The short-chain carboxylic acids normally have a molecular weight of less than 750. The short-chain carboxylic acids for the purposes of the invention may have one, two, three or more carboxyl groups. The carboxyl groups may be wholly or partly an ester, anhydride, lactone, amide, imidic acid, lactam, lactim, dicarboximide, carbohydrazide, hydrazone, hydroxame, hydroxime, amidine, amide oxime or nitrile.

Derivatives of the short-chain carboxylic acids are short-chain carboxylic acids which are mono-, di-, tri- or polysubstituted along the carbon chain or the cyclic structure. Examples of substituents of the carboxylic acids of the invention include C1-C8-alkyl, C2-C8-alkenyl, aryl, aralkyl and aralkenyl, hydroxymethyl, C2-C8-hydroxyalkyl, C2-C8-hydroxyalkenyl, aminomethyl, C2-C8-aminoalkyl, cyano, formyl, oxo, thioxo, hydroxyl, mercapto, amino, carboxyl or imino groups. Preferred substituents are C1-C8-alkyl, hydroxymethyl, hydroxyl, amino and carboxyl groups.

Examples which may be mentioned of short-chain carboxylic acids of the invention are formic acid, acetic acid, propionic acid, butyric acid, lactic acid, citric acid, isobutyric acid, valeric acid, isovaleric acid, pivalic acid, oxalic acid, malonic acid, salicylic acid, tartaric acid, succinic acid, glutaric acid, glyceric acid, glyoxylic acid, adipic acid, pimelic acid, suberic acid, azelaic acid, sebacic acid, propiolic acid, crotonic acid, isocrotonic acid, elaidic acid, maleic acid, fumaric acid, muconic acid, citraconic acid, mesaconic acid, camphoric acid, o.m.p.-phthalic acid, naphthoic acid, benzoic acid, toluic acid, hydratropic acid, atropic acid, cinnamic acid, isonicotinic acid, nicotinic acid, bicarbamic acid, 4,4′-dicyano-6,6′-binicotinic acid, 8-carbamoyl-octanoic acid, 1,2,4-pentanetricarboxylic acid, 2-pyrrolecarboxylic acid, 1,2,4,6,7-naphthalene-pentaacetic acid, malonaldehydic acid, 4-hydroxyphthalamic acid, 1-pyrazolecarboxylic acid, gallic acid or propanetricarboxylic acid.

In a preferred embodiment, the preparation comprises as short-chain carboxylic acid (ii) benzoic acid and/or salts of benzoic acid and/or esters of benzoic acid and/or benzoic acid derivatives and/or salts of benzoic acid derivatives and/or esters of benzoic acid derivatives.

Preferred benzoic acid derivatives are mono-, di- and tri-hydroxy-substituted benzoic acid.

Examples which may be mentioned are m-hydroxybenzoic acid, o-hydroxybenzoic acid and p-hydroxybenzoic acid.

Examples which may be mentioned are 2,4-dihydroxybenzoic acid, 2,5-dihydroxybenzoic acid, 2,5-dihydroxybenzoic acid, 2,6-dihydroxybenzoic acid, 3,5-dihydroxybenzoic acid, 3,6-dihydroxybenzoic acid, 2,4,6-trihydroxybenzoic acid.

Mono-hydroxy-substituted benzoic acids are particularly preferred, especially p-hydroxybenzoic acid.

Methyl benzoate, ethyl benzoate, n-propyl benzoate and isopropyl benzoate, and ethyl p-hydroxybenzoate, sodium methyl p-hydroxybenzoate, propyl p-hydroxybenzoate, sodium p-hydroxybenzoate, methyl p-hydroxybenzoate and sodium methyl p-hydroxybenzoate are preferred.

In a further embodiment, said benzoates can be employed as mixtures with one another.

Salts of the short-chain carboxylic acids which may be mentioned are alkali metal and/or alkaline earth metal salts and ammonium salts. Alkali metal salts which may be mentioned are: lithium, sodium, potassium and cesium salts. Sodium and/or potassium salts are particularly preferred. Alkaline earth metal salts which may be mentioned are calcium, strontium and magnesium salts, particularly preferably calcium and magnesium salts.

Esters of the short-chain carboxylic acids which may be mentioned are the esters with alcohols. Suitable alcohols are both monofunctional and bifunctional, as well as polyfunctional (more than 2 hydroxyl groups) ones. Suitable alcohols are both linear and branched alcohols. Particularly suitable alcohols have from 1 to 10 C atoms, in particular from 1 to 6 C atoms. Examples which may be mentioned are: methanol, ethanol, n-propanol, isopropanol, n-butyl alcohol, i-butyl alcohol. Preference is given to methanol, ethanol, n-propanol and isopropanol. Further suitable esters are esters with alcohols having more than one hydroxyl group, such as, for example, glycols, and an example which may be mentioned is 1,2-propanediol, or triols such as, for example, glycerol.

Preferred esters are methyl, ethyl, n-propyl and isopropyl esters.

It is particularly preferred to use the acids and/or salts and/or esters of formic acid, acetic acid, propionic acid, fumaric acid, salicylic acid, citric acid, lactic acid and/or tartaric acid.

The use of sodium propionate is very particularly preferred.

In a further embodiment, said short-chain carboxylic acids, salts and/or esters can be employed mixed with one another.

Examples which may be mentioned are:
preparations comprising potassium diformate, benzoic acid and propionic acid;
preparations comprising potassium diformate, p-hydroxybenzoic acid and propionic acid;
preparations comprising potassium diformate, benzoic acid and sodium propionate;
preparations comprising potassium diformate, p-hydroxybenzoic acid and sodium propionate;
preparations comprising potassium diformate, sodium benzoate and sodium propionate;
preparations comprising potassium diformate, sodium benzoate and propionic acid;
preparations comprising potassium diformate, benzoic acid and formic acid;
preparations comprising potassium diformate, benzoic acid and acetic acid;
preparations comprising potassium diformate, benzoic acid, acetic acid and formic acid;
preparations comprising potassium diformate, sodium benzoate and formic acid;
preparations comprising potassium diformate, sodium benzoate and acetic acid;
preparations comprising potassium diformate, sodium benzoate, acetic acid and formic acid;
preparations comprising potassium diformate, benzoic acid and fumaric acid;
preparations comprising potassium diformate, benzoic acid and salicylic acid;
preparations comprising potassium diformate, benzoic acid and citric acid;
preparations comprising potassium diformate, benzoic acid and lactic acid;
preparations comprising potassium diformate, benzoic acid and tartaric acid;
preparations comprising potassium diformate, benzoic acid, sodium propionate;
preparations comprising potassium diformate, benzoic acid, sodium propionate and formic acid;
preparations comprising potassium diformate, benzoic acid, sodium propionate and acetic acid;
preparations comprising potassium diformate, benzoic acid, sodium propionate and fumaric acid;
preparations comprising potassium diformate, benzoic acid, sodium propionate and salicylic acid;
preparations comprising potassium diformate, benzoic acid, sodium propionate and lactic acid;
preparations comprising potassium diformate, benzoic acid, sodium propionate and tartaric acid;
preparations comprising potassium diformate, sodium benzoate, sodium propionate;
preparations comprising potassium diformate, sodium benzoate, sodium propionate and formic acid;
preparations comprising potassium diformate, sodium benzoate, sodium propionate and acetic acid;
preparations comprising potassium diformate, sodium benzoate, sodium propionate and fumaric acid;
preparations comprising potassium diformate, sodium benzoate, sodium propionate and salicylic acid;
preparations comprising potassium diformate, sodium benzoate, sodium propionate and lactic acid;
preparations comprising potassium diformate, sodium benzoate, sodium propionate and tartaric acid;
preparations comprising potassium diformate, p-hydroxybenzoate, sodium propionate;
preparations comprising potassium diformate, p-hydroxybenzoate, sodium propionate and formic acid;
preparations comprising potassium diformate, p-hydroxybenzoate, sodium propionate and acetic acid;
preparations comprising potassium diformate, p-hydroxybenzoate, sodium propionate and fumaric acid;
preparations comprising potassium diformate, p-hydroxybenzoate, sodium propionate and salicylic acid;
preparations comprising potassium diformate, p-hydroxybenzoate, sodium propionate and lactic acid;
preparations comprising potassium diformate, p-hydroxybenzoate, sodium propionate and tartaric acid;

In a further embodiment, the preparations of the invention may comprise further ingredients besides (i) and (ii). The choice of the further ingredients in this case depends on the chosen area of use of the preparations obtainable in this way. Examples of further ingredients which are mentioned for the purposes of the present invention are the following substances: vitamins, carotenoids, trace elements, antioxidants, enzymes, amino acids, minerals, emulsifiers, stabilizers, preservatives, binders, anticaking agents and/or flavorings.

In a further embodiment, the preparations of the invention may comprise carriers. In this embodiment, the diformates are preferably bound to the carriers. Suitable carriers are “inert” carrier materials, i.e. materials which show no adverse interactions with the components employed in the preparation of the invention. It is, of course, necessary that the carrier material is acceptable for the particular uses as auxiliary, e.g. in animal feeds. Suitable carrier materials are both inorganic and organic carriers. Examples to be mentioned of suitable carrier materials are: low molecular weight inorganic or organic compounds and high molecular weight organic compounds of natural or synthetic origin. Examples of suitable low molecular weight inorganic carriers are salts such as sodium chloride, calcium carbonate, sodium sulfate and magnesium sulfate, kieselguhr or silica or silica derivatives such as, for example, silicon dioxides, silicates or silica gels. Examples of suitable organic carriers are, in particular, sugars such as, for example, glucose, fructose, sucrose, and dextrins and starch products. Examples to be mentioned of high molecular weight organic carriers are: starch and cellulose products such as, in particular, corn starch, corn cob meal, ground rice husks, wheat bran or cereals meals such as, for example, wheat meal, rye meal, barley meal and oatmeal or bran or mixtures thereof.

In a further embodiment, the preparations of the invention may comprise additives. “Additives” mean substances which improve the product properties such as dusting characteristics, flow properties, water-uptake capacity and storage stability. Additives and/or mixtures thereof may be based on sugars, e.g. lactose or maltodextrin, based on cereal or leguminous products, e.g. corn cob meal, wheat bran and soybean meal, based on mineral salts, inter alia calcium magnesium, sodium, potassium salts, as well as D-pantothenic acid or the salts thereof themselves (D-pantothenic acid salt prepared chemically or by fermentation).

The preparations of the invention may comprise the further ingredients, carriers and additives in mixtures.

The preparations of the invention are produced in the simplest case by mixing the components. Production can likewise take place by mixing solutions of the components (i) and (ii) and, where appropriate, subsequent removal of the solvents. Production by mixing melts of the two components is also conceivable.

The simplest form of mixing is the bringing together of the components in a mixer. Such mixers are known to the skilled worker, for example as supplied by Ruberg, Lödige, Drais, Engelsmann etc. The mixers may be operated batchwise or continuously. In a batch mixer, the components to be mixed are introduced in the desired ratio and then mixed for a sufficient time in the range from minutes to hours. The mixing time and the mixing stress are fixed so that the two components are homogeneously distributed in the mixture. In the case of continuous mixing, the two components are added continuously, where appropriate after premixing. In a continuous mixer too, the residence time and mixing stress should be chosen so that both components are homogeneously distributed in the mixture. The mixing time is frequently shorter and the stress greater in the continuous case than in the case of batchwise mixing. The mixing is normally carried out at room temperature, but may also be carried out at higher or lower temperatures. In a preferred embodiment, the mixings are carried out at temperatures above 25° C., in particular above 40, especially above 60° C. The mixing can be carried out under atmospheric pressure, in vacuo or under elevated pressure. Mixing under atmospheric pressure is to be preferred for the mixing tasks described herein.

In a further embodiment, the components can be mixed in the form of melts. In this case it is possible either for both components or for only one of the two components to be molten. If the two components are mixed in the form of melts, it is possible to employ for this purpose typical apparatuses well known to those skilled in the area of emulsifying techniques. Examples thereof are stirred tanks in the batchwise mode of operation, and static mixers, orifices or toothed disk emulsifier machines in the continuous case. If the two melts are not miscible, the mixing results in one of the two components being dispersed in the other one. In the case where the components are miscible, a homogeneous mixture results. The melt obtained in this way is then solidified. Examples of apparatuses employed for this purpose are cooling belts, cooling rolls, prilling towers, fluidized bed spraying or other apparatuses known to the skilled worker for solidification. If only one of the two components is molten, then dispersing apparatuses are used to distribute the solid in the melt. Dispersing apparatuses which can be employed are stirred vessels or other solid/liquid mixers known to the skilled worker. The solidification of the mixture takes place in the same way as described above for the mixing of two melts.

It is possible to mix the two components in dissolved form or to disperse one component as solid in a solution of the other component. Examples of suitable solvents are water or organic solvents, preferably employing water for component (i) and preferably employing water and/or organic solvents for component (ii). These mixtures are then converted by drying into a solid having the desired properties (e.g. particle size, apparent density, stability). Drying processes are known to the skilled worker from the literature, e.g. O. Krischer, W. Kast, Trocknungstechnik, first volume “Die wissenschaftlichen Grundlagen der Trocknungstechnik” Springer-Verlag 1978 (ISBN 3-540-08280-8) or Krischer/Kröll, Trocknungstechnik, second volume “Trockner und Trocknungsverfahren”, Springer-Verlag 1959, and K. Kröll, W. Kast, Trocknungstechnik, third volume, “Trocknen und Trockner in der Produktion” (ISBN 3-540-18472-4) or in K. Masters, “Spray Drying Handbook”, Longman Scientific & Technical 1991 (ISBN 0-582-06266-7), or else H. Uhlemann, L. Mörl: “Wirbelschicht-Sprühgranulation” (ISBN 3-540-66985-X).

A further preferred form of the preparation of the two components is to vaporize one component and deposit it on the other component. Processes of this type are known from the literature as sublimation or desublimation processes. They are frequently used to obtain substances in very pure form. The process is employed here for applying one substance homogeneously onto the other. In the process, the volatile substance (e.g. component (ii)) is converted from the solid or liquid form into the gas phase (vaporized, evaporated or sublimed) preferably at elevated temperature and low pressure. It is possible to use as evaporation apparatus (evaporator or sublimator) all technical apparatuses which can be heated and/or evacuated, e.g. stirred containers and mixers. The vapor of the volatile component is then deposited on the other component in the desublimator, the second component favorably having a lower temperature than the first component in the sublimator. Examples of possible apparatuses for depositing the component are mixers, fixed beds or fluidized beds.

In a preferred embodiment, the preparations are in solid form. Depending on the application requirement, the preparations may be in the form of a powder having an average particle size of from 1 μm to 10 000 μm, preferably an average particle size of from 10 μm to 5 000 μm, preferably having an average particle size of from 20 μm to 1 000 μm, particularly preferably having an average particle size of from 100 μm to 800 μm.

The resulting products in powder form are investigated in the Mastersizer S instrument from Malvern Instruments GmbH. To describe the width of the particle size distribution, the values of D(v,0.1), D(v,0.5) and D(v,0.9) were determined for the powders, and the average particle size of the distribution D[4,3] has been indicated.

The mixtures of component (i) (diformates) and component (ii) (short-chain carboxylic acids) may be present in any ratios by weight relative to one another, and ratios by weight of (i) to (ii) of from 0.01:1 to 1:0.01 are preferred, ratios by weight of (i) to (ii) of from 0.1:1 to 1:0.1 are particularly preferred, and ratios by weight of (i) to (ii) of from 0.3:1 to 1:0.3 are very particularly preferred.

Mixtures of component (i) and component (ii) are possible as pure blends, i.e. the two substances are mixed together in the desired particle sizes and concentration ratios, where appropriate with addition of further additives, it also being possible for one or both substances to be protected where necessary also by, for example, a coating. Core/shell structures can also be employed, i.e. component (i) is present inside as core and component (ii) outside as shell—or vice versa. Further coatings are of course employed where necessary with these structures too. It is also conceivable to encapsulate the two substances together in a common matrix of carrier materials or protective colloids. Examples thereof are known to the skilled worker and are described for example in R. A. Morten: Fat-Soluable Vitamins, Pergamon Press, 1970, pages 131 to 145.

The powders can be produced by crystallization, precipitation, drying, granulation or agglomeration processes familiar to the skilled worker or other processes described in relevant textbooks for forming solids.

A preferred of the embodiment of the process results in preparations whose surface is at least 50%, in particular at least 70, very particularly preferably at least 80, especially at least 90%, covered by (ii).

One aspect of the present invention relates to a process for producing the preparations of the invention, in which at least one diformate is coated by desublimation of component (ii).

In this process, component (ii) is sublimed and desublimed, i.e. deposited, on the preparations to be coated. Processes of this type are known from the literature as sublimation or desublimation processes. The process of the invention makes it possible to apply components (ii) homogeneously and in desired layer thicknesses. The process of sublimation and desublimation is described in Ullmann's Encyclopedia of Industrial Chemistry, Sixth Edition, 2000 Electronic Release, chapter 4.1. Suitable evaporators (sublimators) are those described in Ullmann, loc. cit., chapter 5.1, condensers (desublimators) described in chapter 5.2, and apparatus designs and connections are described in FIGS. 5,6,7,9 and 10, to which express reference is made here. A fluidized bed may be mentioned as a further possible condenser.

One aspect of the present invention relates to a process for producing preparations comprising at least one diformate, in which at least one diformate is introduced, where appropriate together with further ingredients and/or additives, into a suitable apparatus and coated with component (ii), where appropriate with addition of further ingredients.

Examples of suitable apparatuses which may be mentioned are: mixers, fluidized bed, coating drums, Kugelcoaters, etc.

The diformates which are advantageously in powder form (e.g. in crystalline, amorphous form, in the form of adsorbates, extrudates, granulates and/or agglomerates) are for this purpose introduced into the suitable apparatus, preferably into a fluidized bed or a mixer. The diformates are introduced where appropriate together with so-called additives and further ingredients. Plowshares, paddles, screws or the like ensure more or less vigorous mixing of the product. Conventional examples are plowshare mixers, orbiting screw mixers or similar apparatuses.

It is also possible to employ very shallow, box- or trough-shaped designs having one or more screws. Further designs are high-speed mixers such as, for example, the Turbolizer® mixer/coater from Hosokawa Micron B.V., and all types of drum coaters or coating drums.

An alternative possibility is mixing of the product by movement of the entire container. Examples thereof are tumbling mixers, drum mixers or the like. A further possibility is to use pneumatic mixers. Mixing of solids is described for example in Ullmann's Encyclopedia of Industrial Chemistry, Sixth Edition, 2000, Mixing of Solids.

The coating can be carried out either directly in the apparatus downstream.

Said process can be carried out either continuously or batchwise (in mixers operating batchwise or continuously as appropriate).

It may be necessary in some cases when applying the coating agent or immediately after/before this to add dusting agents such as talc, silicates or the like to prevent sticking.

The metering/addition of the coating agent takes place where appropriate together with further ingredients normally through devices for dropwise or spray application. Examples thereof are injectors, spray heads, single-fluid or multifluid nozzles, in rare cases rotating dripping or atomizing devices. In the simplest case, local addition as concentrated jet stream is also possible.

One aspect of the present invention relates to a process for producing preparations comprising at least one diformate, in which component (ii) is introduced, where appropriate with the addition of further ingredients, into a suitable apparatus, and diformates (i) are added, where appropriate together with further ingredients and/or additives.

In one embodiment of this process, the initially solid coating agent is put into a suitable apparatus and melted or softened as a result of heating of the wall of the apparatus or of the shaft or as a result of the mechanical energy input. The diformates and where appropriate further ingredients and/or additives are added and coated with the molten or softened.

In one embodiment of this process, carriers are introduced into the mixer in addition to the component (ii) and premixed where appropriate and, as a result of high mechanical energy input in the same or in separate apparatuses (examples are all the mixers already mentioned as well as low-speed mills and dryers), the diformates and, where appropriate, further ingredients and/or additives are coated.

The addition of components (ii) can take place under superatmospheric, atmospheric or subatmospheric pressure, preferably under atmospheric and subatmospheric pressure.

It may be advantageous in some cases to preheat or cool the diformates and, where appropriate, further ingredients and/or additives and/or the components (ii) (change in viscosity, change in the wetting properties, influence on solidification properties), and feed in or withdraw heat via the container wall and/or the mixing implements. It may be necessary in some cases to remove water vapors or solvent vapors. The wetting properties can also be changed by adding surface-active substances such as emulsifiers or the like.

To improve the coating properties, it may be advantageous for the mixer to be evacuated and, where appropriate, blanketed with protective gas. This should be repeated several times depending on component (ii).

The addition of the diformates, where appropriate further ingredients and/or additives, and of component (ii) may if required take place at different sites in the apparatus.

In a further embodiment of the present invention, the preparations of the invention are produced batchwise or continuously in fluidized beds. The particles are agitated by the fluidizing gas which is hot or cooled where appropriate. Suitable as fluidizing gas is, for example, air or else inert gas (e.g. nitrogen). It may be worthwhile in some cases to feed in or withdraw heat via the container wall and via heat exchanger surfaces immersed in the fluidized bed. Suitable fluidized beds, and the necessary peripherals, are known in the art.

The batchwise or continuous metering and, where appropriate, the preheating of the diformates, where appropriate of the further ingredients and additives, takes place with the aid of the devices described above, which are known to the skilled worker.

For example, the diformates can be introduced into a fluidized bed. They are fluidized and coated by spraying on an aqueous or nonaqueous solution or dispersion or a melt of a suitable component (ii).

Internals known in the prior art which assist defined mixing of the solid to be coated are beneficial. Examples thereof are rotary displacers, Wurster pipes or else specially fabricated fluidized bed base geometries (inclination and/or perforation of the base) or assisting defined agitation of the solid by sensibly disposed nozzles, e.g. tangentially disposed single- or twin-fluid or multifluid nozzles.

The preparations of the invention may in some cases be produced advantageously in a combination of mixer and fluidized bed.

One aspect of the present invention relates to a process for producing preparations comprising at least one diformate, in which at least one diformate is dispersed, where appropriate together with further ingredients and/or additives, in melts of suitable components (ii), and then the dispersions obtained in this way are divided and solidified.

In one embodiment of this process it is possible for the diformates, where appropriate together with further ingredients and/or additives, to be employed in the form of a melt.

In a further embodiment, the preparations of the invention are obtained by at least one diformate (and where appropriate the further ingredients and/or additives) being suspended in melts of components (ii) and then the dispersions obtained in this way being atomized and/or divided and allowed to solidify.

These suspensions are then atomized in a stream of cooled gas—with and without use of dusting agents—so that coated preparations comprising diformates are produced. These processes are known to the skilled worker for example under the names spray cooling, spray solidification, prilling or melt encapsulation, and solidifying on cooling belts, rolls, pelletizing plates and belts.

The melts are preferably produced in a first step before the diformates are added and suspended. The suspending can take place batchwise in a stirred vessel or else continuously in, for example, pumps suitable for this purpose or simply in injectors and pipe lines as a result of sufficiently high turbulence. It is also possible to use static mixers. Protective heating of the necessary parts of the system—including the lines and atomizing units—is known to the skilled worker.

Air and nitrogen are suitable and preferred as cooling gas. The gas flow can be cocurrent, countercurrent or crossflow. The process can be carried out in conventional spraying, prilling towers or other containers. Fluidized beds with and without holdup are likewise suitable. The process can be operated batchwise or continuously. The solid can be removed for example in cyclones or filters. Alternatively, it is conceivable for the solid to be collected, with and without after-cooling, in fluidized beds or mixers.

Suitable atomizing units are nozzles (single- and twin-fluid nozzles or special designs) and atomizing wheels or atomizing disks or plates or atomizing baskets—or special designs thereof.

In a further embodiment, the dispersions obtainable in this way are atomized and solidified in liquids in which neither the diformates nor components (ii) are soluble. A conventional solid/liquid separation with subsequent drying leads to the preparation of the invention.

A further aspect of the present invention relates to a process for producing preparations comprising at least one diformate, in which at least one diformate, where appropriate further ingredients and/or additives, are dispersed in component (ii), emulsified in an aqueous solution of a protective colloid, preferably gelatin and/or gelatin derivatives or/and gelatin substitutes with addition of one or more substances from the group of mono-, di- and polysaccharides, and subsequently subjected to a shaping and subsequent or simultaneous drying.

Very fine-particle diformates are preferably employed in this process and are obtained for example by precipitation, crystallization, spray drying or grinding.

In one embodiment, one or more emulsifiers and/or stabilizers can be added to the diformates before the dispersion in the lipophilic component.

The dispersions obtained in this way (oil droplets containing the diformates) are emulsified in a subsequent process step in an aqueous solution of a protective colloid, preferably gelatin or/and gelatin derivatives or/and gelatin substitutes with addition of one or more substances from the group of mono-, di- and polysaccharides, preferably corn starch. The emulsions obtained in this way are subjected to a shaping by spraying and subsequent or simultaneous drying.

In a further embodiment, the preparations of the invention comprise at least one diformate bound to a carrier.

The preparations bound to a carrier are produced by production processes known to the skilled worker, such as, for example, by adsorbing the preparations of the invention in liquid form onto the carrier substances.

The preparations of the invention are very substantially stable on storage, which is advantageous especially when they are used in animal feeds.

The preparations of the invention are suitable for use in feeds for animals (animal feeds). Examples which may be mentioned are: pigs, cows, poultry and domestic animals, especially piglets, breeding sows, fattening pigs and calves.

The preparations of the invention are particularly suitable as addition to animal feeds in the form of feed additives.

Feed additives are, according to the Animal Feeds Act, in particular substances intended to be added singly or in the form of preparations to animal feeds in order to
influence the characteristics of the animal feed or of the animal products,
cover the animals' requirements for certain nutrients or active substances, or improve animal production, in particular by acting on the gastrointestinal flora or the digestibility of the animal feeds or by reducing nuisances caused by the animals' excreta, or
achieve particular nutritional purposes or cover certain temporary nutritional needs of the animals.

Feed additives also include substances which are approved as additives by a statutory instrument under § 4, para. 1, No. 3b of the Animal Feeds Act.

The preparations of the invention are particularly suitable as so-called “acidifiers”. Acidifiers means substances which reduce the pH. These include substances which reduce the pH in the substrate (e.g. animal feed) and those which reduce the pH in the animal's gastrointestinal tract.

The preparations of the invention are particularly suitable as performance enhancers. In a preferred embodiment, the preparations of the invention are employed as performance enhancers for pigs, poultry and young ruminants.

The compositions of animal feeds are such as to cover optimally the appropriate nutrient requirements of the particular species. Those generally chosen are vegetable feed components such as corn, wheat or barley meal, unextracted soybean meal, extracted soybean meal, extracted linseed meal, extracted rapeseed meal, grass meal or pea meal as crude protein sources. In order to ensure an appropriate energy content of the feed, soybean oil or other animal or vegetable fats are added. Since the vegetable protein sources comprise only an inadequate amount of some essential amino acids, feeds are frequently supplemented with amino acids. These are in particular lysine and methionine. In order to ensure the supply of minerals and vitamins to the agricultural livestock, minerals and vitamins are also added. The type and amount of the added minerals and vitamins depends on the species and is known to the skilled worker (see, for example, Jeroch et al., Ernährung landwirtschaftlicher Nutztiere, Ulmer, UTB). Complete feeds which contain all the nutrients in the ratio to one another which covers requirements can be used to cover the nutrient and energy requirements. It may form the sole feed for the animals. Alternatively, a feed supplement can be added to a cereal grain feed. This comprises protein-, mineral- and vitamin-rich feed mixes which supplement the feed in a sensible way.

The preparations of the invention are further suitable as preservatives, especially as preservatives for green fodder and/or animal feed.

It has been found that the preparations of the invention can be employed advantageously in the production of silage. They speed up lactic fermentation and prevent after-fermentation and inhibit the development of harmful yeasts. A further aspect of the invention therefore relates to the use of the preparations of the invention as ensiling agents (ensuing aids).

A further aspect of the present invention relates to the use of the preparations of the invention in fertilizers.

### EXAMPLE 1

### Mixture of Potassium Diformate with Benzoic Acid

30 g of dry crystalline potassium diformate were mixed with 30 g of powdered benzoic acid by hand in a glass beaker. Mixing was continued until the mixture was visibly homogeneous. The resulting mixture was stored in the open under ambient air and in a desiccator and was more stable on storage than pure potassium diformate.

### EXAMPLE 2

### Potassium Diformate with Benzoic Acid, Storage at 60° C.

Part of the mixture from example 1 was stored in a closed vessel at 60° C. over a period of 24 hours. There was slight caking of the powder. After the powder had been stirred up by hand it showed better storability than pure potassium diformate.

### EXAMPLE 3

### Potassium Diformate with Benzoic Acid, Melting

A mixture as in example 1 was treated in a pressure-resistant container at 130° C. for a period of 7 hours in a drying oven. The mixture melted at this temperature. The container with contents was then cooled to room temperature. The fused contents were broken up and tested for storage stability. The storability proved to be better than the mixtures of example 1 and 2.

### EXAMPLE 4

### Potassium Diformate with Sodium Benzoate (Powder)

80 g of crystalline potassium diformate were mixed with 20 g of finely ground sodium benzoate in a glass beaker. The mixture was stored in a desiccator and showed slightly better storage stability than pure potassium diformate.

### EXAMPLE 5

### Potassium Diformate with Sodium Benzoate (Liquid)

10 g of crystalline potassium diformate in a glass beaker were sprayed with 1 g of saturated methanolic sodium benzoate solution (about 5% strength) and dried in a vacuum drying oven. The powder produced in this way remained free-flowing under ambient conditions.

### EXAMPLE 6

### Mixture of Potassium Diformate with Sodium Propionate

30 g of dry crystalline potassium diformate is mixed with 30 g of powdered sodium propionate are by hand in a glass beaker. Mixing is continued until the mixture is visibly homogeneous. The resulting mixture is stored in the open under ambient air and in a desiccator.

### EXAMPLE 7

### Potassium Diformate with Sodium Propionate, Storage at 60° C.

Part of the mixture from example 6 is stored in a closed vessel at 60° C. over a period of 24 hours.

### EXAMPLE 8

### Potassium Diformate with Sodium Propionate, Melting

A mixture as in example 5 is treated in a pressure-resistant container at 130° C. for a period of 7 hours in a drying oven. The mixture melts at this temperature. The container with contents is then cooled to room temperature. The fused contents are broken up and tested for storage stability.

### EXAMPLE 9

### Potassium Diformate with Sodium Propionate (Powder)

80 g of crystalline potassium diformate are mixed with 20 g of finely ground sodium propionate in a glass beaker. The mixture is stored in a desiccator.

### EXAMPLE 10

### Potassium Diformate with Sodium Propionate (Liquid)

10 g of crystalline potassium diformate in a glass beaker are sprayed with 1 g of saturated methanolic sodium benzoate solution (about 5% strength) and dried in a vacuum drying oven.

1. A preparation comprising
(i) at least one diformate of the general formula
XH(COOH)₂, where X=Na, K, Cs, NH₄ and
(ii) at least one carboxylic acid and/or at least one salt of the carboxylic acid and/or at least one ester of the carboxylic acid and/or at least one derivative of the carboxylic acid, where the compounds employed as carboxylic acid (ii) are selected from the group consisting of acetic acid, propionic acid, butyric acid, lactic acid, citric acid, isobutyric acid, valeric acid, isovaleric acid, pivalic acid, oxalic acid, malonic acid, salicylic acid, tartaric acid, succinic acid, glutaric acid, glyceric acid, glyoxylic acid, adipic acid, pimelic acid, suberic acid, azelaic acid, sebacic acid, propiolic acid, crotonic acid, isocrotonic acid, elaidic acid, maleic acid, fumaric acid, muconic acid, citraconic acid, mesaconic acid, camphoric acid, o., m., p.-phthalic acid, naphthoic acid, benzoic acid, toluic acid, hydratropic acid, atropic acid, cinnamic acid, isonicotinic acid, nicotinic acid, bicarbamic acid, 4,4′-dicyano-6,6′-binicotinic acid, 8-carbamoyloctanoic acid, 1,2,4-pentanetricarboxylic acid, 2-pyrrolecarboxylic acid, 1,2,4,6,7-naphthalenepentaacetic acid, malonaldehydic acid, 4-hydroxyphthalamic acid, 1-pyrazolecarboxylic acid, gallic acid or propanetricarboxylic acid.

2. A preparation as claimed in claim 1, wherein potassium diformate is employed as diformate.

3. A preparation as claimed in claim 1 and/or 2, wherein the carboxylic acid employed is
(iii) benzoic acid and/or the salts of benzoic acid and/or esters of benzoic acid and/or derivatives of benzoic acid and/or the salts of benzoic acid derivatives and/or esters of benzoic acid derivatives.

4. A preparation as claimed in at least one of the preceding claims, wherein sodium propionate is employed as (ii).

5. A preparation as claimed in at least one of the preceding claims, wherein the ratios by weight of (i) to (ii) are between 0.01:1 and 1:0.01.

6. A preparation as claimed in at least one of the preceding claims in solid form, especially in the form of a powder, especially in the form of a powder having an average particle size of from 1 μm to 10 000 μm.

7. A preparation as claimed in claim 6, which is in the form of a powder having an average particle size of from 10 μm to 5 000 μm.

8. A preparation as claimed in any of the preceding claims, which comprises further ingredients and/or additives and/or carriers.

9. A process for producing preparations as claimed in claim 1, which comprises mixing (i) with (ii).

10. A process as claimed in claim 9, wherein a solution of (i) and/or (ii) is mixed with a solution of (i) and/or (ii) and, where appropriate, the solvent(s) is(are) subsequently removed.

11. A process for producing preparations comprising
(i) at least one diformate of the general formula
XH(COOH)₂, where X=Na, K, Cs, NH₄ and
(ii) at least one carboxylic acid and/or at least one salt of the carboxylic acid and/or at least one ester of the carboxylic acid and/or at least one derivative of the carboxylic acid, where the carboxylic acid comprises up to 12 C atoms, characterized in that (i) and/or (ii) are mixed in the form of a melt with (ii) and/or (i)

12. A process for producing preparations comprising
(i) at least one diformate of the general formula
XH(COOH)₂, where X=Na, K, Cs, NH₄ and
(ii) at least one carboxylic acid and/or at least one salt of the carboxylic acid and/or at least one ester of the carboxylic acid and/or at least one derivative of the carboxylic acid, where the carboxylic acid comprises up to 12 C atoms, in which
(i) at least one diformate is mixed where appropriate with further ingredients and/or additives,
(b) the mixture obtained in this way is coated with at least one carboxylic acid and/or at least one salt of the carboxylic acid and/or at least one ester of the carboxylic acid and/or at least one derivative of the carboxylic acid.

13. A process for producing preparations comprising
(i) at least one diformate of the general formula
XH(COOH)₂, where X=Na, K, Cs, NH₄ and
(ii) at least one carboxylic acid and/or at least one salt of the carboxylic acid and/or at least one ester of the carboxylic acid and/or at least one derivative of the carboxylic acid, where the carboxylic acid comprises up to 12 C atoms, in which
(a) at least one carboxylic acid and/or at least one salt of the carboxylic acid and/or at least one ester of the carboxylic acid and/or at least one derivative of the carboxylic acid are introduced into a suitable apparatus where appropriate with the addition of further ingredients,
(ii) at least one diformate is added, where appropriate together with further ingredients and/or additives.

14. A process for producing preparations comprising
(i) at least one diformate of the general formula
XH(COOH)₂, where X=Na, K, Cs, NH₄ and
(ii) at least one carboxylic acid and/or at least one salt of the carboxylic acid and/or at least one ester of the carboxylic acid and/or at least one derivative of the carboxylic acid, where the carboxylic acid comprises up to 12 C atoms, in which at least one diformate is coated by desublimation of at least one carboxylic acid and/or at least one salt of the carboxylic acid and/or at least one ester of the carboxylic acid and/or at least one derivative of the carboxylic acid.

15. A process for producing preparations comprising
(i) at least one diformate of the general formula
XH(COOH)₂, where X=Na, K, Cs, NH₄ and
(ii) at least one carboxylic acid and/or at least one salt of the carboxylic acid and/or at least one ester of the carboxylic acid and/or at least one derivative of the carboxylic acid, where the carboxylic acid comprises up to 12 C atoms, in which
(a) at least one diformate, where appropriate together with other ingredients and/or additives, is dispersed in at least one carboxylic acid and/or at least one salt of the carboxylic acid and/or at least one ester of the carboxylic acid and/or at least one derivative of the carboxylic acid,
(b) emulsified in an aqueous solution of a protective colloid, preferably gelatin or/and gelatin derivatives or/and gelatin substitutes with the addition of one or more substances from the group of mono-, di- and polysaccharides,
(c) and subjected to a shaping by spraying and subsequent or simultaneous drying.

16. The use of a preparation as claimed in at least one of the preceding claims in premixes for animal feeds.

17. The use of a preparation as claimed in at least one of the preceding claims in feed additives and/or animal feeds, in particular for pigs, poultry and calves.

18. A process for producing a diformate-containing feed and/or feed additive, which comprises
(i) adding preparation as claimed in any of claims 1 to 8 to a premix,
(ii) mixing the premix obtained in this way with the other ingredients of the feed and/or feed additive.

19. An animal feed comprising a preparation as claimed in at least one of the preceding claims.

20. The use of a preparation as claimed in at least one of the preceding claims as performance enhancer and/or growth promoter.

21. The use of a preparation as claimed in at least one of the preceding claims as acidifier.

22. The use of a preparation as claimed in at least one of the preceding claims as preservative.

23. The use of a preparation as claimed in at least one of the preceding claims as ensiling agent.

24. The use of a preparation comprising
(i) at least one diformate of the general formula XH(COOH)₂, where X=Na, K, Cs, NH₄ and
(ii) at least one carboxylic acid and/or at least one salt of the carboxylic acid and/or at least one ester of the carboxylic acid and/or at least one derivative of the carboxylic acid, where the carboxylic acid comprises up to 12 C atoms,
in fertilizers.
